(19) United States
(12) Patent Application Publication
(10) Pub. No.: US 2004/0134961 A1
(43) Pub. Date: Jul. 15, 2004

(54) Combustion-engined setting tool

(76) Inventors: Iwan Wolf, Chur (CH); Ulrich Rosenbaum, Wangs (CH); Ulrich Schiestl, Feldkirch (AT); Hans Gschwend, Buchs (CH); Nikolaus Hannoschoeck, Grabs (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/743,169

(22) Filed: Dec. 22, 2003

(30) Foreign Application Priority Data
Dec. 23, 2002 (DE) 102 60 704.4

(51) Int. Cl. B25C 1/14

(52) U.S. Cl. 227/10

(57) ABSTRACT

A combustion-engined setting tool for driving fastening elements, such as nails, bolts, and the like in an object includes a combustion chamber (11), a piston guide (17) adjoining the combustion chamber (11), a drive piston (15) arranged in the piston guide (17) and displaceable in a setting direction under action of expanding gases produced in the combustion chamber (11) upon combustion of fuel, and an electrically driven device (5) for pre-compressing oxidation medium necessary for effecting a combustion process in the combustion chamber (11) and/or the fuel.

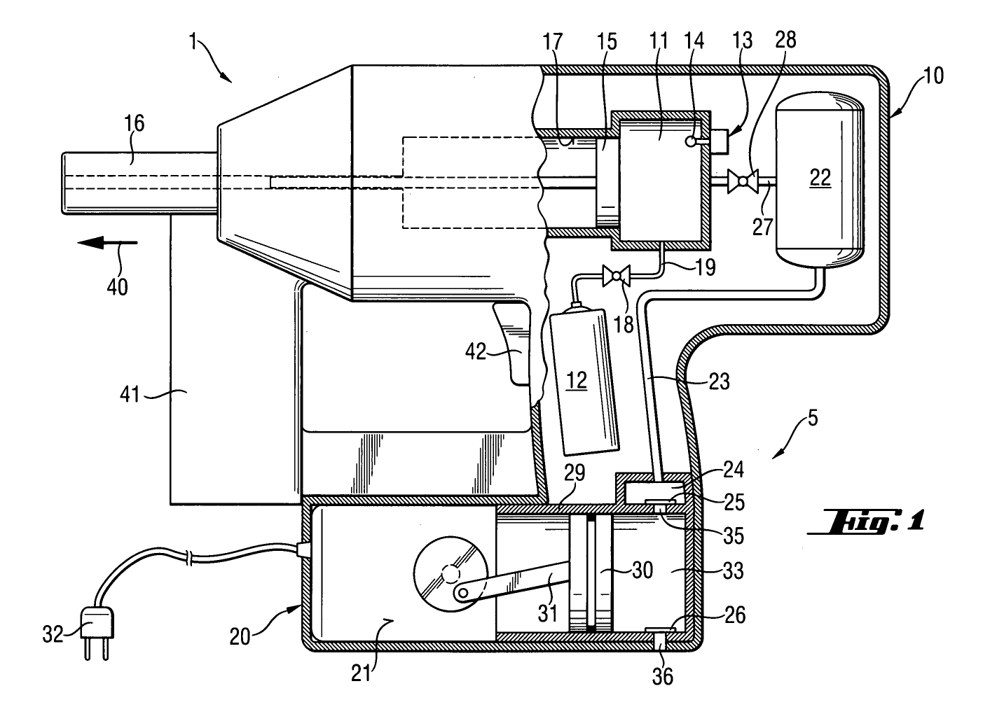

### BACKGROUND OF THE INVENTION

1. Field of the Invention

The present invention relates to a combustion engined setting tool for driving fastening elements, such as nails, bolts, and the like in an object and including a combustion chamber in which fuel is combusted, a piston guide adjoining the combustion chamber, and a drive piston arranged in the piston guide and displaceable in a setting direction under action of expanding gases produced in the combustion chamber upon combustion of the fuel.

2. Description of the Prior Art

Setting tools of the type described above can be operated with gaseous or vaporized liquid fuel which is combusted in the combustion chamber, providing for driving of the drive piston. It is generally desirable to achieve a good thermal efficiency. German Publication DE-42 43 617 A1 discloses a setting tool in which a cylinder with a pre-combustion chamber is arranged beneath the piston in the setting direction. In the initial position of the setting tool, the piston is located directly above the pre-combustion chamber in its maximum remote, from the main combustion chamber, position. The pre-compression of the fuel-air mixture, which fills the main combustion chamber, in this setting tool, is effected by ignition of a fuel-air mixture in the pre-combustion chamber, whereby the piston is accelerated in a direction toward the main combustion chamber. This results in an isentropical compression of the air-fuel mixture in the main combustion chamber.

The drawback of this solution consists in that the setting tool of DE-42 43 617 A is mechanically very complicated and is susceptible to wear.

Accordingly, an object of the present invention is a setting tool in which the drawback of the known prior art tool is eliminated and the thermal efficiency is increased.

### SUMMARY OF THE INVENTION

This and other objects of the present invention, which will become apparent hereinafter, are achieved by providing, in the setting tool, an electrically driven device for pre-compressing oxidation medium necessary for effecting a combustion process in the combustion chamber and/or the fuel. The provision of an electrically driven pre-compressing device permits to feed, into the combustion chamber, a fuel-oxidation medium mixture compressed during operation of the setting tool. The combustion of the pre-compressed fuel-air mixture leads to a very high thermal efficiency of combustion.

The pre-compression of the oxidation medium and/or fuel or of a fuel-oxidation medium mixture can be effected, e.g., with an electrically driven compression device. The energy for the pre-compression can be the result of efforts of a setting tool user or be obtained from the impact energy of the setting tool. Ideally, the electrically driven pre-compression device is controlled automatically by electronic control means, without intervention of the use.

The compression device can be formed, e.g., as an electrically driven compressor.

According to an advantageous embodiment of the setting tool, there is provided a storage reservoir which can be formed, e.g., as a pressure container. The storage reservoir can be used for storing of the compressed oxidation medium, or the compressed fuel, or the oxidation medium-fuel mixture. The use of the compressed fuel medium permits, advantageously, to conduct quickly following one another, setting processes. Alternatively, a process with multiple impacts becomes possible. The pre-compressing device can be formed with relatively small dimensions, as it can operate continuously during operation of the setting tool.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

Single FIGURE of the drawings shows a side, partially cross-sectional view of a combustion-engine setting tool according to the present invention.

### DETAILED DESCRIPTION OF THE PREFERRED EMBODIMENT

A combustion-engined setting tool 1 according to the present invention, which is shown in the FIGURE, can be driven with a fuel gas or with a vaporized liquid fuel. The setting tool 1 includes a housing 10 and a setting mechanism located in the housing 10. Upon the setting tool being pressed, with its bolt guide 16, against an object (not shown), the setting mechanism drives a fastening element such as, e.g., a nail, a bolt, or the like in the constructional component. The setting mechanism includes, among others, a combustion chamber 11, a piston guide 17, a drive piston 15 displaceably supported in the piston guide 17, and bolt guide 16 for a fastening element. The fastening element is driven into the object by an end of the drive piston 15 facing in the setting direction 40. The bolt guide 16 is adjoined, at its end facing in the direction opposite to the setting direction, by the piston guide 17. Fastening elements are stored, e.g., in a magazine 21 secured to the setting tool.

An ignition device 13, which includes ignition means, is arranged in the combustion chamber 11. As the ignition means, e.g., a spark plug 14 can be used, which ignites an oxidation medium-fuel mixture fed into the combustion chamber 11. The fuel is fed in the combustion chamber 11 from a fuel tank 12 or another fuel source through a conduit 19. A valve 18, e.g., a mechanical or electronic metering valve, is arranged in the fuel conduit 19. With the valve 18, which is controlled by mechanical or electronic control means (not shown), an amount of fuel fed into the combustion chamber 11 can be controlled. In addition, pressure sensing means (not shown) such as, e.g., a pressure sensor, can be arranged in the combustion chamber 11. With a pressure sensor, the oxidation medium-fuel mixture can be automatically ignited when the pressure in the combustion chamber 11 reaches a predetermined level. The automatic ignition of the oxidation means-fuel mixture can be effected with evaluating electronics which is connected with the pressure sensor and the ignition device 13 and which evaluates the pressure pulse generated by the pressure sensor and compares it with a set valve. In the transition region between the combustion chamber 11 and the piston guide 17, there can be provided magnet means (not shown). The magnet means can be used for retaining the drive piston 15 with a predetermined holding force in its initial position at an end of the piston guide 17 adjacent to the combustion chamber 11.

The setting tool 1 further includes an electrically driven device 5 for pre-compression which includes a compression device 20. The compression device 20 includes, e.g., a compressor provided with a piston 30 which is displaceably arranged in a cylinder 29 and is driven by an electrical drive 21. The piston 30 is connected with the electrical drive 21 by a connecting rod 31. As an electrical drive, a contact device 32 can be used. The electrical contact device 32, e.g., a network cable with a plug, can be connected to an electrical supply circuit or a generator, which supplies the electrical energy necessary for the operation. However, an accumulator, a battery or the like, which can be provided in or on the setting tool, can also be used as a source of electrical energy. The cylinder 29 has an inlet 36 through which an oxidation air is aspirated thereinto, and an outlet 35 through which a compressed air can be expelled. The air inlet 36 is provided with valve means 26 that provides for entering of the air into the cylinder. The valve means 26 blocks flow of the air in opposite direction, preventing the air from flowing out through the inlet 36.

Valve means 25, which is provided at the outlet 35, enables air flow out of the cylinder 29 in its open condition and block flow of air into the cylinder 29 in its closed condition. The outlet 35 opens into a chamber 24 that communicates with a cylinder chamber 33 in the open condition of the outlet 35. A conduit 23 connects the chamber 24 with a storage reservoir 22, e.g., a pressure container. The storage reservoir 22 is connected with the combustion chamber 11 via a pressure conduit 27 in which a control valve 28 is arranged. The opening and closing of the control valve 28 is controlled by appropriate control means (not shown) to fed a compressed air from the storage reservoir 21 into the combustion chamber 11. As has already been discussed above, the storage reservoir 22 is filled, upon operation of the setting tool 1, with air, oxidation medium, by the compression device 20 via the conduit 23. In the storage reservoir 22, the air is retained under pressure.

The setting tool 1 is actuated, upon having been pressed against a constructional component or another object, with a trigger switch 42 provided on the setting tool 1. It should be noted that instead of the oxidation medium, the entire oxidation medium-fuel mixture can be pre-compressed by the compression device and be fed, in its compressed state, into the combustion chamber 11.

It should also be pointed out that the oxidation means or the oxidation means-fuel mixture can be pre-compressed directly in the combustion chamber 11. In this case, the storage reservoir can be eliminated.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A combustion-engined setting tool for driving fastening elements in an object, comprising a combustion chamber (11) for combusting fuel; a piston guide (17) adjoining the combustion chamber (11); a drive piston (15) arranged in the piston guide (17) and displaceable in a setting direction under action of expanding gases produced in the combustion chamber (11) upon combustion of the fuel; and an electrically driven device(5) for pre-compressing at least one of oxidation medium necessary for effecting a combustion process in the combustion chamber (11) and the fuel.

2. A setting tool according to claim 1, wherein the pre-compressing device (5) comprises compression means (20) for compressing the oxidation medium.

3. A setting tool according to claim 2, wherein the compression means (20) comprises an electrically driven compressor.

4. A setting tool according to claim 1, further comprising a storage reservoir (22) for the at least one of oxidation medium and fuel, and a pressure conduit (23) for connecting the storage reservoir (22) with the pre-compressing device (5).

5. A setting tool according to claim 4, wherein the storage reservoir (22) is formed as a pressure container.

6. A setting tool according to claim 4, further comprising a pressure conduit (27) extending between the storage reservoir (22) and the combustion chamber (11), and a control valve (28) provided in the pressure conduit (27) extending between the storage reservoir (22) and the combustion chamber (11) for controlling pressure of the oxidation medium-fuel mixture in the combustion chamber (11).
